(19) United States
(12) Patent Application Publication
(10) Pub. No.: US 2016/0005293 A1
(43) Pub. Date: Jan. 7, 2016

(54) DISASTER SITUATION MANAGEMENT SYSTEM AND PERSONAL IDENTIFICATION TERMINAL ASSOCIATED WITH THE SAME

(71) Applicant: NATIONAL DISASTER MANAGEMENT INSTITUTE, Seoul (KR)

(72) Inventors: Byungtae YOO, Seoul (KR); Keumho OH, Goyang-si (KR); Jongseol LEE, Goyang-si (KR)

(21) Appl. No.: 14/521,453

(22) Filed: Oct. 22, 2014

(30) Foreign Application Priority Data
Jul. 1, 2014 (KR) 10-2014-0081817

(51) Int. Cl. G08B 21/10

(52) U.S. Cl. CPC G08B 21/10

(57) ABSTRACT

Disclosed herein are a disaster situation management system and a personal identification terminal associated with the system. For this, the disaster situation management system includes a personal identification terminal detachably worn on a body of a user and configured to input and store information including personal information and location information of the user, a center server configured to enable communication with the personal identification terminal through a communication network, and configured to collect personal information and location information of each user who wears the personal identification terminal from the personal identification terminal and to manage the collected information, and a hospital server configured to enable communication with the center server through the communication network, collect personal information and location information of the person who wears the personal identification terminal, and provide the collected information to the center server, the collected information being read through a reader.

### BACKGROUND OF THE INVENTION

1. Field of the Invention

The present invention relates, in general, to a disaster situation management system and a personal identification terminal associated with the system and, more particularly, to a disaster situation management system and a personal identification terminal associated with the system, which can easily detect personal information, location information and even the state information of each person involved in a disaster when the disaster occurs, and can provide the detected information.

2. Description of the Related Art

When accidents related to a large number of persons occur, such as accidents involving group tours, ships or aircraft, or large-scale chemical accidents, it is very important to detect the personal information of individual persons affected by the corresponding accident, and to detect the location and state information of these persons.

In particular, it is true that, when the above information is not promptly transferred, or when inaccurate information is transferred, serious damage or injury to victims and persons involved may occur.

Recently, a management system capable of rapidly detecting the location of victims has been presented, and an example thereof is Korean Patent Application Publication No. 10-2006-0011232.

However, the above technology is focused only on the detection of a location, but does not provide a system capable of promptly providing information about a hospital to which each rescued person is evacuated and the current state (physical and mental injury condition) of the person.

### SUMMARY OF THE INVENTION

Accordingly, the present invention has been made keeping in mind the above problems occurring in the prior art, and an object of the present invention is to provide technology that enables communication to be performed between a center server, provided in a rescue center or a national disaster management center when a disaster or emergency occurs, and a personal identification terminal attached to each person and configured to provide personal information and location information, thus promptly collecting personal information and location information of each person and minimizing injury.

Another object of the present invention is to provide technology, in which a center server is connected to a hospital server, and in which the hospital server is provided with information recorded in a personal identification terminal and transfers the information to the center server, and also provides information about the physical condition or the like of each person, thus enabling a rescue center or a national disaster management center to promptly aggregate the current locations and states of respective persons.

A further object of the present invention is to provide technology that can promptly and precisely provide requested location and state information when a request for an inquiry into the location and state information of a victim is received from the family or relatives of the victim or other persons involved.

In order to accomplish the above objects, the present invention provides a disaster situation management system, including a personal identification terminal detachably worn on a body of a user and configured to input and store information including personal information and location information of the user; a center server configured to enable communication with the personal identification terminal through a communication network, and configured to collect personal information and location information of each user who wears the personal identification terminal from the personal identification terminal and to manage the collected information; and a hospital server configured to enable communication with the center server through the communication network, collect personal information and location information of the person who wears the personal identification terminal, and provide the collected information to the center server, the collected information being read through a reader.

The disaster situation management system may further include a hospital terminal related to the hospital server, wherein, when a physical condition or a degree of injury of a person who wears a specific personal identification terminal is input through the hospital terminal, the input information is transferred to the center server through the hospital server.

The center server may be configured to, when a request for provision of personal information or state information of a specific person who wears the personal identification terminal is received from an external terminal through a website or an application associated with the center server, provide the location information or state information to the requesting terminal.

The personal identification terminal may include a main body and a band part connected to the main body and wound around the user's wrist or ankle, and the main body includes an input unit for enabling input of information, a display unit for displaying information, an information provision unit for providing input information to the reader, and a Global Positioning System (GPS) communication module for communicating with a GPS satellite.

Further, the present invention provides a personal identification terminal associated with a disaster situation management system, including a main body; and a band part connected to the main body and wound around a part of a body of a user, wherein the main body comprises an input unit for enabling input of personal information of a person; a GPS module for transmitting and receiving signals related to location determination while communicating with a GPS satellite; a storage unit for storing personal information and location information of the person; an information provision unit for, when a read signal from an external reader is provided, providing the information input to the storage unit to the external reader; a communication unit for communicating, through a communication network, with a center server that collects personal information and location information of each person; and a control unit for entirely controlling the units.

The control unit may perform control such that, when an information provision request signal is received from the center server, the personal information and location information of the person stored in the storage unit are transmitted to the center server through the communication unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic diagram showing a personal identification terminal and a disaster situation management system associated with the terminal according to the present invention;

FIG. 2 is a control block diagram showing the personal identification terminal and the disaster situation management system associated with the terminal according to the present invention; and

FIGS. 3 and 4 are control flowcharts of the present invention.

### DESCRIPTION OF THE PREFERRED EMBODIMENTS

Hereinafter, the present invention will be described in detail with reference to embodiments. Objects, features, and advantages of the present invention will be easily understood based on the following embodiments. The present invention is not limited to the embodiments and may be embodied in various forms. The embodiments proposed here are provided to those skilled in the art so that disclosed content is thoroughly and completely provided and so that the spirit of the present invention is sufficiently transmitted to those skilled in the art to which the present invention pertains. Therefore, it should be noted that the present invention is not limited by the following embodiments.

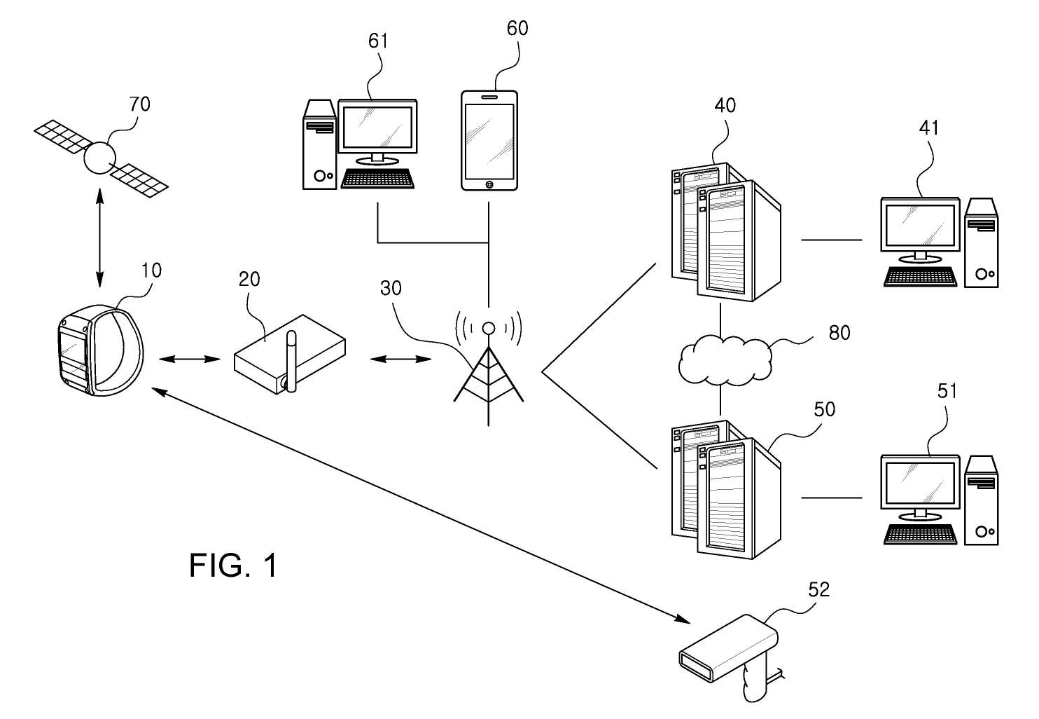

FIG. 1 is a schematic diagram showing a personal identification terminal and a disaster situation management system associated with the terminal according to the present invention.

As shown in FIG. 1, the disaster situation management system according to the present invention includes a personal identification terminal 10 attachable to the wrist or ankle of each person, a wireless Access Point (AP) 20 configured to exchange communication signals with the personal identification terminal 10, a broadband base station 30 configured to exchange communication signals with the wireless AP 20, a center server 40 operated by a rescue center or a national disaster management center, and a center terminal 41 connected to the center server 40.

Further, the disaster situation management system according to the present invention includes a hospital server 50 connected to the center server 40 through a network 80, a hospital terminal 51, and a reader 52.

Meanwhile, the family or relatives of a disaster victim or persons involved in the disaster may access a disaster situation management website or application operated by the rescue center, the national disaster management center, a local government, or the government by using an external terminal 60 or 61, and may then be provided with real-time disaster situation information.

The personal identification terminal 10 is preferably implemented in the shape of a wrist watch or a band, but is not limited to such a shape.

Each person is prompted to input his or her personal information to his or her personal identification terminal 10 immediately before the departure of a group tour, or immediately before boarding a bus, a ship or an airplane, and thus the personal identification terminal 10 may be regarded as a kind of electronic identification device.

Alternatively, when a disaster occurs and a person is rescued, the personal identification terminal 10 is placed and worn on the person, and the personal information of the rescued person is caused to be input through the personal identification terminal 10, thus allowing the personal information and location information of the rescued person to be tracked in real time.

Since the personal identification terminal 10 is capable of exchanging Global Positioning System (GPS) location-determination signals with a GPS satellite 70, the location information of the personal identification terminal 10 may be easily collected.

Since the wireless AP 20 and the broadband base station 30 are components of a typical communication network, a detailed description thereof will be omitted.

The center server 40 is a server that is operated by the rescue center or the national disaster management center, and that communicates, through the communication network, with personal identification terminals 10 distributed to respective persons, thus collecting and identifying the personal information and location information of the respective persons wearing the personal identification terminals 10.

Therefore, when a large-scale disaster occurs, the number of victims or the location information of the victims may be promptly and precisely collected.

The hospital server 50 is connected to the center server 40 and is also connected to the reader 52 or to the hospital terminal 51.

Therefore, when the information of the terminal 10 (personal information and location information) of an evacuated victim is read through the reader 52, or when the personal information, location information, and state information (degree of an injury, or survival or death information) of the evacuated victim are input through the hospital terminal 51, the read or input information is transferred to the hospital server 50, and then transferred to and collected by the center server 40.

In particular, when a large number of evacuated persons and several hospitals to which the persons have been evacuated are present, it is possible to promptly and precisely aggregate the number of victims who have been evacuated to a specific hospital and the number of victims who have been evacuated to other hospitals. Also, it is possible to promptly and precisely aggregate the degrees of injury of the evacuated victims.

Further, such information may be provided to the website or application.

When family, relatives or persons involved access the website or application through the terminal 60 or 61, the personal information and location information of the corresponding victim, the degree of injury of the victim, etc. may be easily detected.

In this case, a predetermined authentication procedure may be included to protect the personal information of each victim.

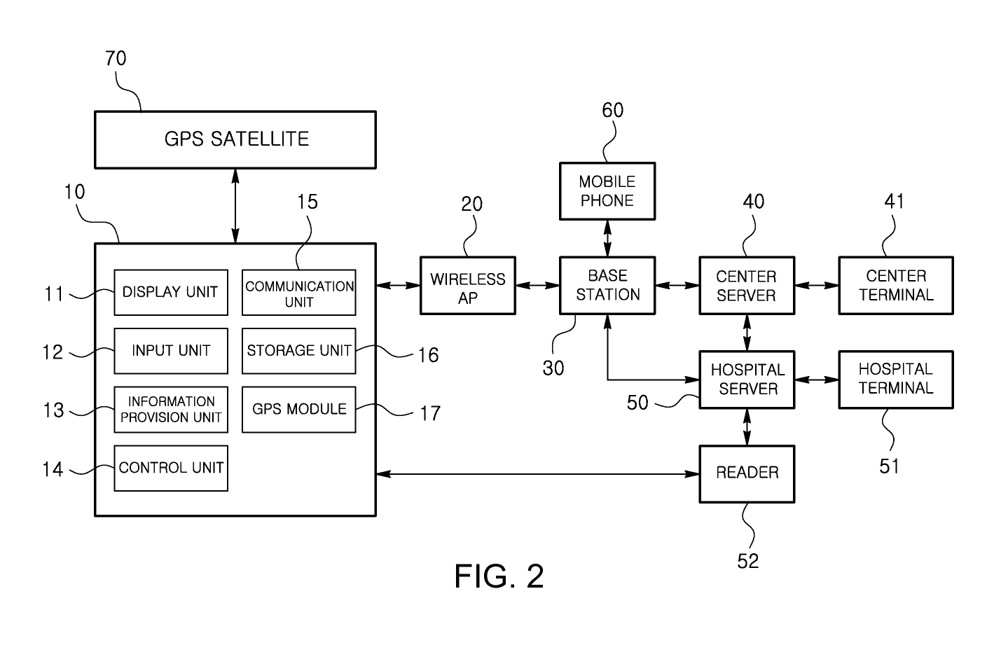

FIG. 2 is a control block diagram showing the personal identification terminal and the disaster situation management system associated with the terminal according to the present invention.

Below, the detailed configuration of the personal identification terminal 10 included in the disaster situation management system will be described with reference to FIG. 2.

In the personal identification terminal 10, a main body and a band or strap connected to the main body form the appearance thereof.

The main body includes a display unit 11 implemented as a liquid crystal screen and an input unit 12 for enabling the input of information. The display unit 11 and the input unit 12 may be regarded as being implemented as a touch screen.

Further, the main body includes a communication unit 15 for communicating with the center server 40 through a communication network, and a storage unit 16 for storing personal information input by the input unit 12 and location information obtained by a GPS module 17, which will be described later.

Meanwhile, the main body is provided with an information provision unit 13 that is configured to, when the reader approaches the terminal 10 in a hospital and a read signal is detected, provide personal information and location information stored in the storage unit 16 to the reader.

The information provision unit 13 is preferably configured as a tag such as a Radio Frequency Identification (RFID) tag, but it is not limited thereto.

A control unit 14 functions to control the above-described components, and may issue a control command to provide personal information and location information through the communication unit 15 especially when a request to provide information is received from the center server 40.

Hereinafter, the control flow of the present invention will be described in detail with reference to the attached drawings.

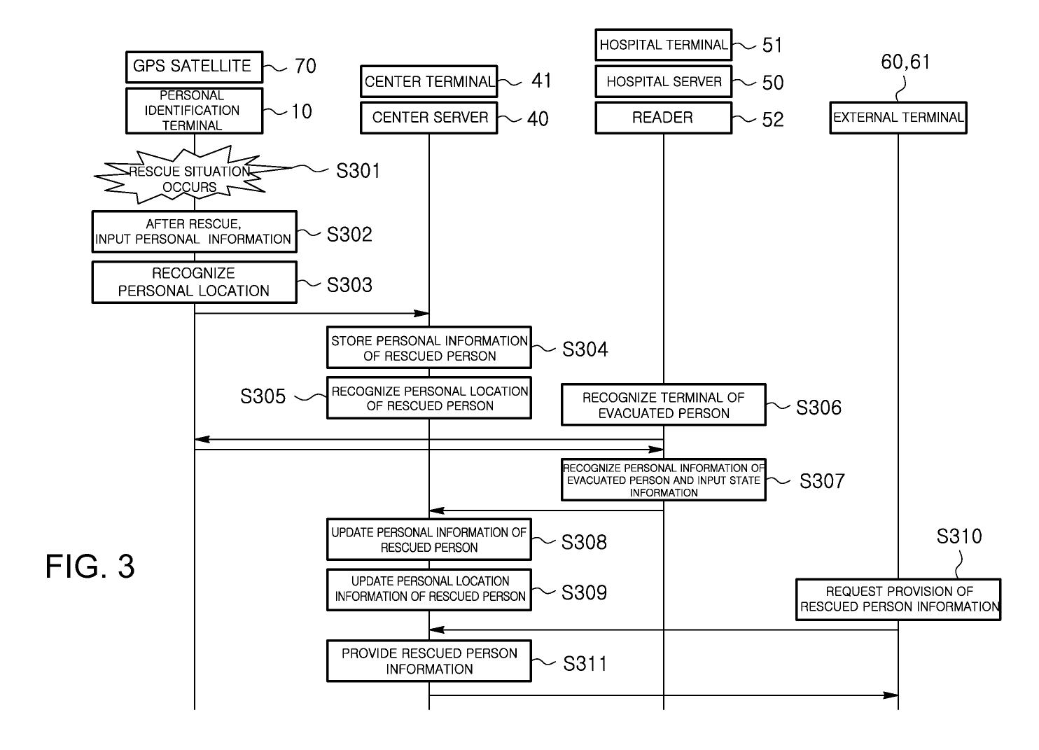

FIG. 3 is a flowchart showing a process performed after the personal identification terminal 10 has been placed and worn on a person rescued via a rescue operation at the time of a disaster.

First, when a rescue situation occurs at step S301, the personnel of a rescue agency puts the personal identification terminal 10 on the rescued person, and prompts the rescued person to input his or her personal information (name, age, address, resident registration number, etc.) at step S302.

Meanwhile, since the personal identification terminal 10 communicates with the GPS satellite 70, it is possible to track a variation in the location of the personal identification terminal 10.

When the personal information is input and the location information is acquired, the information is transferred to the center server 40.

The center server 40 not only stores the personal information of each rescued person, but also recognizes the location of the rescued person at steps S304 and S305. Meanwhile, for a person evacuated to a hospital among rescued persons, the personal information and location information of the person, stored in the terminal thereof, are read using a recognition tool, such as the reader 52, at steps S306 and S307.

However, the personal information or the location information may be directly input through the hospital terminal 51 without being read through the reader 52.

Meanwhile, a doctor or a nurse checks the degree of injury of the evacuated person or whether the evacuated person has been dead, and inputs such state information through the hospital terminal 51, and then the input information is transferred to the center server 40 via the hospital server 50.

In this way, the center server 40 may update the personal information of the rescued person and also update the location information thereof at steps S308 and S309. That is, when the rescued person is evacuated to a hospital, information about the hospital to which the person has been evacuated and the degree of injury of the person may be easily aggregated.

Meanwhile, when the family, relatives or persons involved request the provision of information about a rescued person via the website or application at step S310, the center server may provide recently updated personal information (typical personal information and state information) and location information in response to the request.

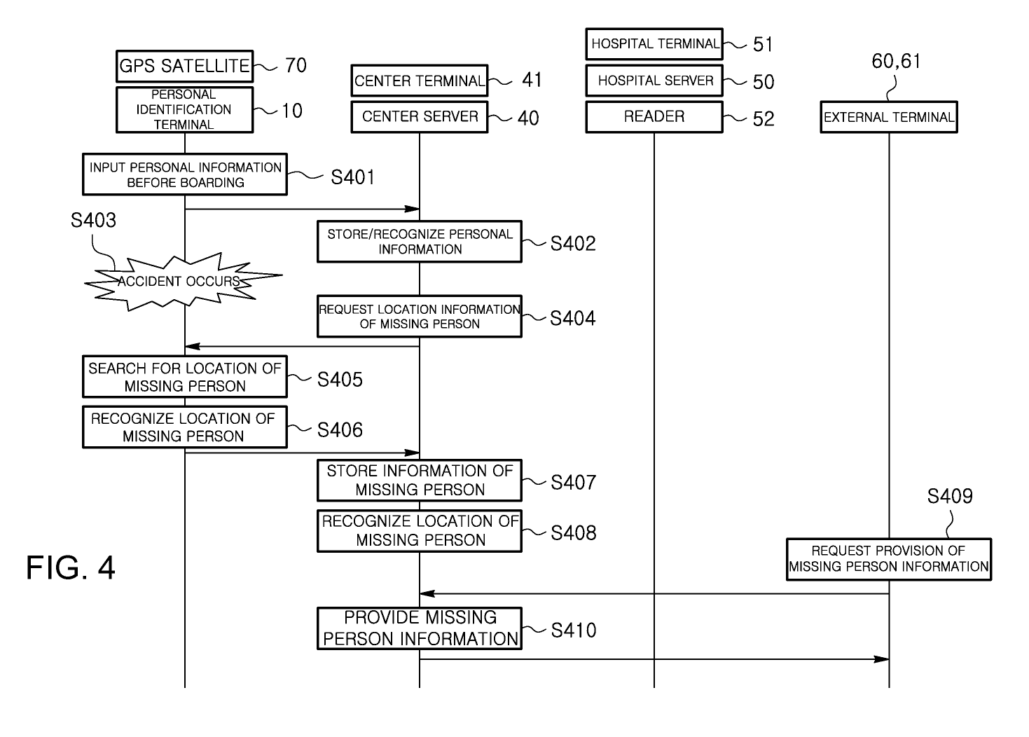

FIG. 4 is a flowchart showing the flow of information management when the personal identification terminal 10 is worn on each person before departure or boarding, and some persons are missing in case of an accident.

The flow of management of information about rescued persons and evacuated persons after the occurrence of an accident is identical to that of FIG. 3, and thus a detailed description thereof will be omitted.

As shown in FIG. 4, personal identification terminals 10 are distributed to and worn on respective persons before boarding a bus, an airplane, or a ship or before the departure of a group tour, and are then configured to prompt the persons to input their personal information at step S401.

The input personal information is transferred to and stored in the center server 40 at step S402.

Thereafter, if an accident occurs and some persons are determined to be missing, the center server 40 requests the provision of location information from the terminals 10 worn on the missing persons at step S404.

The terminals 10, which received the information provision request, search for the current locations of the missing persons and recognize the coordinate points thereof while exchanging location-determination signals with the GPS satellite at steps S405 and S406.

When the locations of the missing persons are finally found, the terminals 10 provide information about the locations to the center server 40, and the center server receives, stores, and recognizes the location information at steps S407 and S408.

Meanwhile, when the family or relatives of each missing person or persons involved request the provision of information about the corresponding missing person via the website or the application at step S409, the center server may provide recently updated information of the missing person (personal information and location information) in response to the corresponding request.

The present invention is advantageous in that it enables communication between a personal identification terminal and a center server, so that the personal information and location information of each person who is involved in an accident or a disaster may be rapidly collected, thus aggregating the number of victims, the number of rescued persons, the number of missing persons, and the respective locations of the persons.

Further, the present invention is advantageous in that a reader that reads information from the information provision unit of a personal identification terminal, or a hospital server that is connected to an external terminal accesses a center server, thus easily detecting the location and personal information of persons evacuated to a hospital.

In particular, in the case of information provided by a hospital server, the physical conditions or degrees of injury of evacuated persons that are input through a hospital terminal may be additionally provided in addition to the personal information and location information of the persons, with the result that survivors, mild injury cases, serious injury cases, and deaths may be promptly aggregated and classified.

Furthermore, the present invention is also advantageous in that, when the family or relatives of an accident victim or persons involved in an accident request the provision of location and state information of the corresponding victim via a website or an application operated by a rescue center, a national disaster management center, a local government, or the government, the requested information may be promptly and precisely provided.

In summary, there are advantages in that, when an accident occurs, information input to each personal identification terminal is read to precisely determine rescued persons, and to detect the locations of persons who are not yet rescued through a communication network, thus allowing the persons to be promptly rescued, with the result that the loss of lives is minimized.

Furthermore, the present invention is also advantageous in that the overall process ranging from rescue to evacuation and medical treatment at the time of an accident may be systematically managed, accident responses may be effectively taken, and persons who are not yet rescued may be promptly rescued, thus minimizing the loss of lives.

As described above, detailed embodiments of the present invention have been described. Those skilled in the art to which the present invention pertains will understand that the present invention may be modified without departing from the essential features of the present invention. Therefore, the disclosed embodiments should be considered from a descriptive standpoint rather than a restrictive standpoint. The scope of the present invention is defined in the accompanying claims rather than the above detailed description, and it should be noted that all differences falling within the claims and equivalents thereof are included in the scope of the present invention.

What is claimed is:

1. A disaster situation management system, comprising:
a personal identification terminal detachably worn on a body of a user and configured to input and store information including personal information and location information of the user;
a center server configured to enable communication with the personal identification terminal through a communication network, and configured to collect personal information and location information of each user who wears the personal identification terminal from the personal identification terminal and to manage the collected information; and
a hospital server configured to enable communication with the center server through the communication network, collect personal information and location information of the person who wears the personal identification terminal, and provide the collected information to the center server, the collected information being read through a reader.

2. The disaster situation management system of claim 1, further comprising a hospital terminal related to the hospital server,
wherein, when a physical condition or a degree of injury of a person who wears a specific personal identification terminal is input through the hospital terminal, the input information is transferred to the center server through the hospital server.

3. The disaster situation management system of claim 2, wherein the center server is configured to, when a request for provision of personal information or state information of a specific person who wears the personal identification terminal is received from an external terminal through a website or an application associated with the center server, provide the location information or state information to the requesting terminal.

4. The disaster situation management system of claim 1, wherein:
the personal identification terminal includes a main body and a band part connected to the main body and wound around the user's wrist or ankle, and
the main body includes an input unit for enabling input of information, a display unit for displaying information, an information provision unit for providing input information to the reader, and a Global Positioning System (GPS) communication module for communicating with a GPS satellite.

5. A personal identification terminal associated with a disaster situation management system, comprising:
a main body; and
a band part connected to the main body and wound around a part of a body of a user,
wherein the main body comprises:
an input unit for enabling input of personal information of a person;
a GPS module for transmitting and receiving signals related to location determination while communicating with a GPS satellite;
a storage unit for storing personal information and location information of the person;
an information provision unit for, when a read signal from an external reader is provided, providing the information input to the storage unit to the external reader;
a communication unit for communicating, through a communication network, with a center server that collects personal information and location information of each person; and
a control unit for entirely controlling the units.

6. The personal identification terminal of claim 5, wherein the control unit performs control such that, when an information provision request signal is received from the center server, the personal information and location information of the person stored in the storage unit are transmitted to the center server through the communication unit.
